(19) United States
(12) Patent Application Publication
(10) Pub. No.: US 2006/0196947 A1
(43) Pub. Date: Sep. 7, 2006

(54) Method and apparatus for providing a handheld stand-alone vertical number scanning calculator apparatus

(76) Inventor: Sigrid Asbjorn Smitt-Jeppesen, Vienna, VA (US)

Correspondence Address: SIGRID SMITT - JEPPESEN, 2232 WAKEROBIN LANE, RESTON, VA, 20191, US

(21) Appl. No.: 11/069,461

(22) Filed: Mar. 1, 2005

(51) Int. Cl. G06K 7/10

(52) U.S. Cl. 235/472.03

(57) ABSTRACT

A handheld vertical scanning calculator apparatus is provided. It allows the user to add paper-borne columns of numbers quickly using just one instrument. The main components are a) a scanning input that scans numbers vertically b) an OCR equipped CPU that recognizes the scanned input c) a calculating unit and finally d) a display. Compared to existing means, the invention is a distinct progress since it a) reduces of time consumption and risk of input errors related with the use of traditional calculators, b) reduces the complications currently related to the combined use of a separate scanner with an external computer or PDA i.e. use of two devices and/or need to scan each individual number in the column separately. Technically the invention is a novelty due to its vertical scanning and since it performs scanning and adding in one instrument.

### CROSS REFERENCE TO RELATED APPLICATIONS

[NOT APPLICABLE]

### STATEMENT REGARDING FEDERALLY SPONSORED RESEARCH OR DEVELOPMENT

[NOT APPLICABLE]

### REFERENCE TO SEQUENCE LISTING

[NOT APPLICABLE]

### BACKGROUND OF THE INVENTION

I. Field of the Invention

The present relates in general to the field of portable electronic apparatus, and in particularly to portable electronic devices, which are useful for scanning written characters. It furthermore relates to the field of electronic calculators.

II. Description of Prior Art

Accountants and employees in the accounting and financial departments of corporations often have a need for, and spend considerable time on, adding and/or subtracting columns of printed numbers. Their current options are either to add the columns using a classic calculator or to input the columns into a number processing computer program through a keypad or with a scanner.

Both these processes have their disadvantages; manually keying columns into a calculator or a computer takes time and leaves room for human error. Scanning the numbers with a regular scanner requires two separate devices, and can be cumbersome if the columns are on different documents, or only parts of the document data is needed.

Some pen scanning devices with text recognition can read numbers, but to do so for an entire column of numbers requires the user to scan each number in the column separately. Furthermore, addition of the numbers would still require an additional device (PC or PDA) since no pen scanner currently has a calculating function built in.

The claimed invention solves these problems by enabling the user to quickly, and with one single device, add entire columns of numbers with one stroke of the invention.

### BRIEF SUMMARY OF THE INVENTION

It is one objective of the present invention to provide a portable handheld device, which combines the functions of scanning, character recognition and electronic calculation.

It is another objective of the present invention to provide a pen-type scanner that can scan entire columns vertically rather than scanning each column number separately in the horizontal direction.

It is another objective of the present invention to provide a pen-type scanner that is a stand-alone device i.e. that is not connected to a computer, a PDA or other device but that can perform its intended purpose by itself.

It is another objective of the present invention to provide a pen-type scanner that can capture images of numbers and other accounting related characters only with great speed and convert these to digital format through an OCR (Optical Character Recognition) type embedded program.

It is another objective of the present invention to provide a pen-type scanner that can, in itself and without an additional device, perform simple addition and/or subtraction operations with the numerical data captured by the scanning function.

It is another objective of the present invention to provide a pen-type scanner that can save the results of one calculation and add or subtract additional data captured from the same or another document.

It is another objective of the present invention to provide a pen-type scanner that is light, portable, battery driven and which can be used in any environment.

### BRIEF DESCRIPTION OF THE DRAWINGS

FIG. 1 is a pictorial view of one particular embodiment of the handheld vertical scanning calculator seen at an angle from above.

FIG. 1A is a cross sectional view of an embodiment of the handheld vertical scanning calculator again seen from above

FIG. 2A is a pictorial view of a paper with text and numbers in columns.

FIG. 2B is a pictorial view of the intended use of the invention.

FIG. 3 is block diagram representation of the components, which make up an embodiment of the handheld vertical scanning calculator

FIG. 4 is flowchart representation of the operation of one embodiment of the handheld vertical scanning calculator

### DETAILED DESCRIPTION OF THE INVENTION

The handheld vertical scanning calculator of the present invention is a device, which makes it easier for a person to quickly add or subtract one or more columns of numbers. The handheld vertical scanning calculator of the present invention is greatly advantageous over the prior art in that it is an easy to use stand-alone device, which neither requires manual keying of the numbers in the columns with the associated risk of human error, nor requires the use of an additional device to treat scanned data.

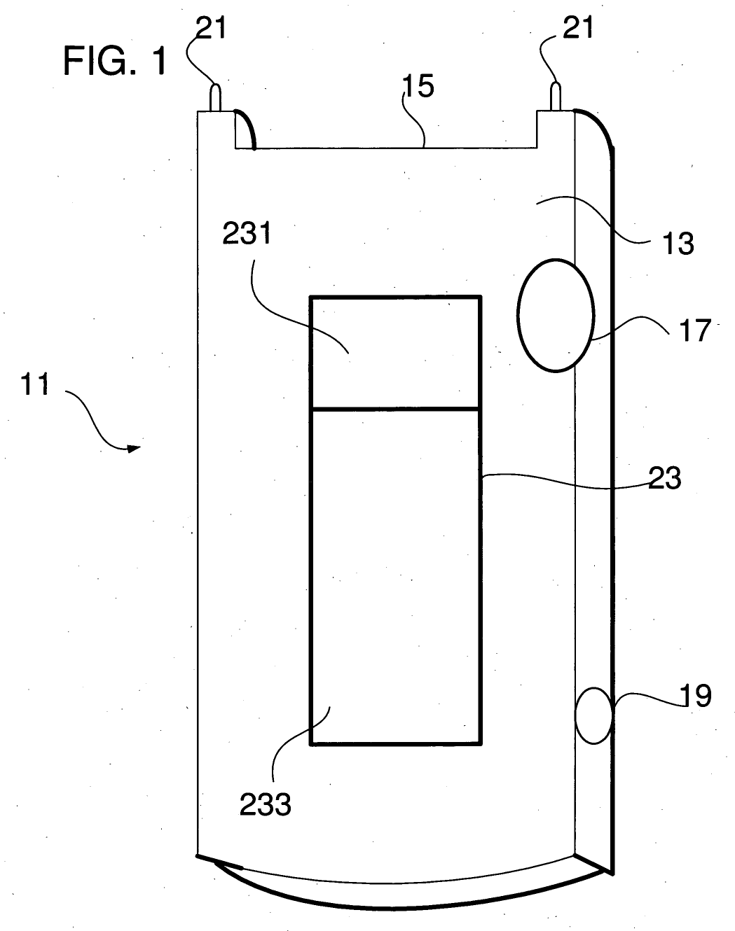

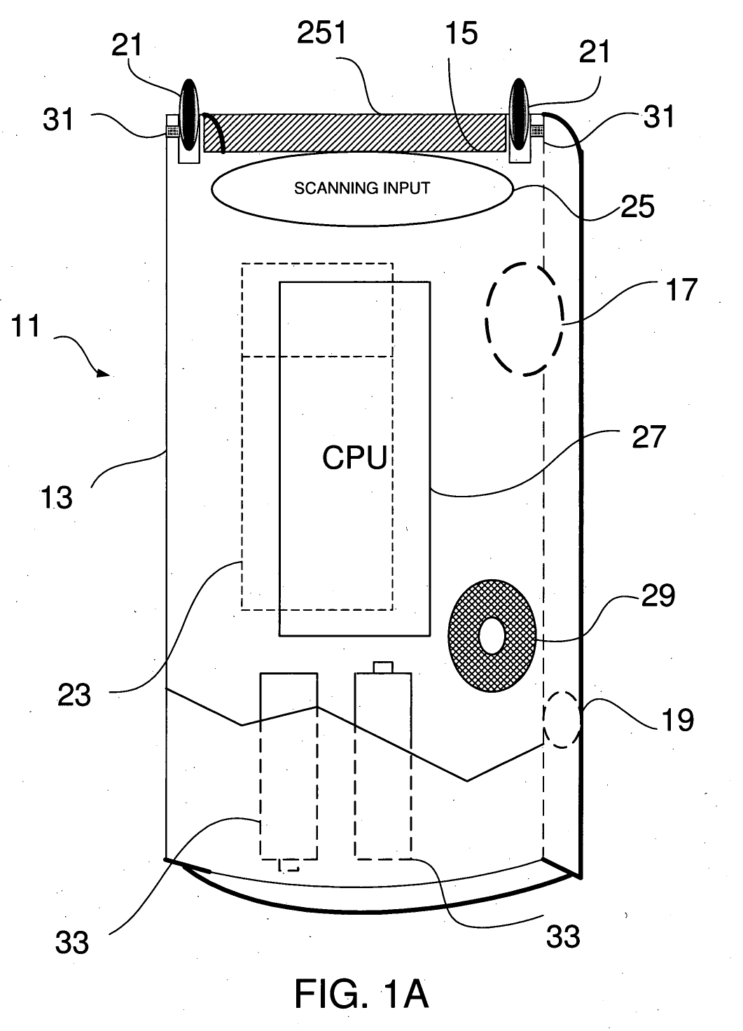

FIG. 1 is a pictorial representation of a particular embodiment of the handheld vertical scanning calculator 11 of the present invention. As shown, the handheld vertical scanning calculator 11 includes a housing 13, which terminates in a recessed approaching end 15 that holds the scanning input 25. On either side of the approaching end is a roller 21, which activates the scanning input 25 when depressed. The housing 13 holds a “clear” button 17 and an on/off button 19. The housing also holds a display 23 which is split into two parts; one 233 for the result of the addition process, and one 231 which indicates the number of figures in the scanned column.

FIG. 1A is a cross sectional view of an embodiment of the handheld vertical scanning calculator 11 of the present invention. As shown, the handheld vertical scanning calculator includes the housing 13, approaching end 15, buttons 17, 19, display 23 and rollers 21 all shown in FIG. 1. Internally, the invention has a scanning input 25, which captures the image of the numbers to be read (and calculated) when they are in the scanning field 251. The embodiment of the invention also comprises a CPU 27 to perform the software processes of the invention; namely the analog to digital conversion, the character recognition and the addition processes as well as the communication with the outputs. The outputs are the display 23 and an audio output in the form of a speaker 29. In order to detect roller depression and scanning speed, there is a sensor 31 placed on the side of each of the rollers 21. The device in this embodiment is powered by two standard batteries 33.

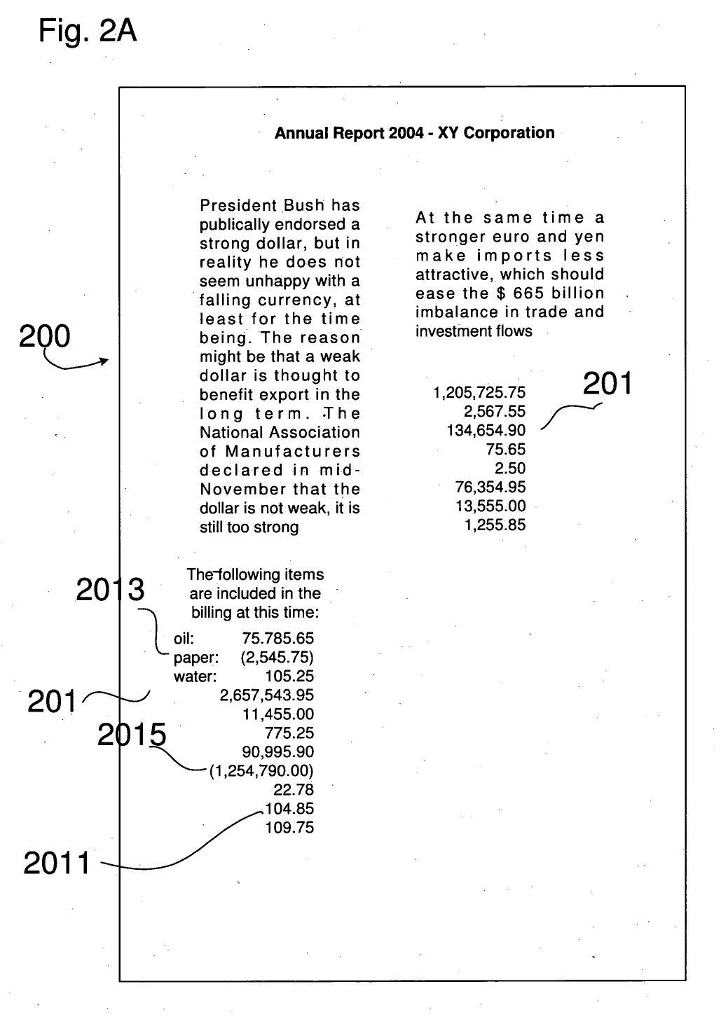

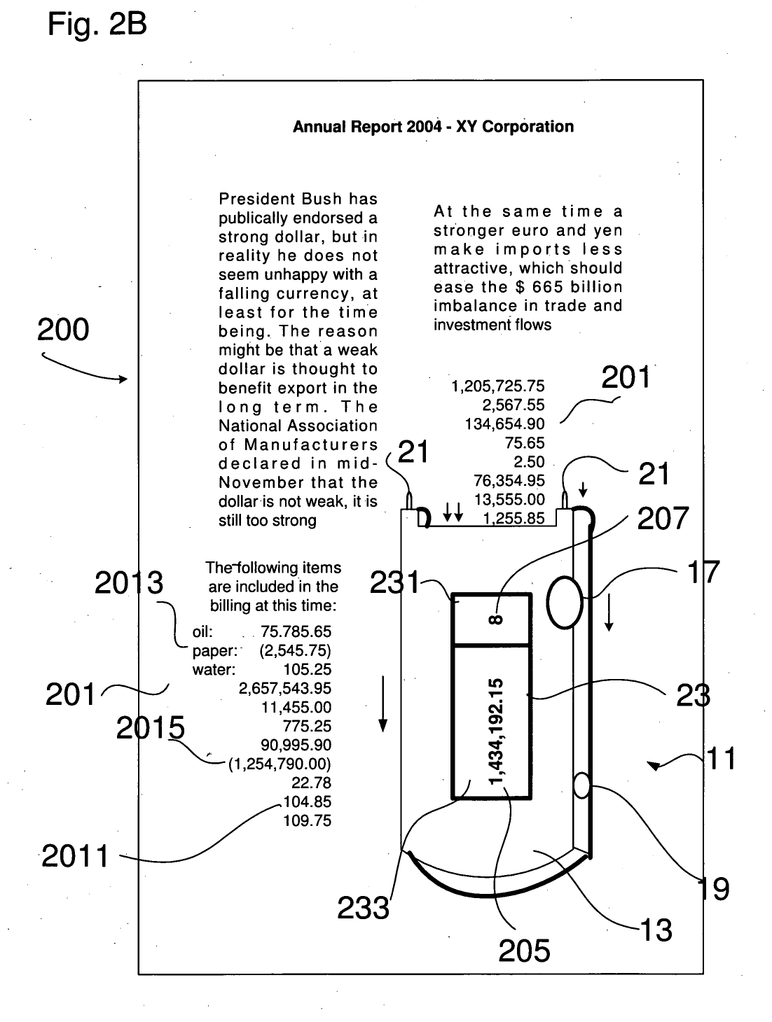

FIG. 2A is a pictorial representation of a page 200 upon which is printed a two columns 201 of numbers 2011, 2015 as well as some column text 2013. On the page 200 is also some additional text 202.

FIG. 2B is a pictorial representation of the intended use of the handheld vertical scanning calculator 11 of the present invention. The rollers 21 are depressed when the device 11 is put to the paper 200 and this activates the scanning input 25. As shown, the handheld vertical scanning calculator 11, held with one hand, is then moved vertically over the column 201 from top to bottom, scanning the column numbers 2011. At the end of the column, the device 11 is taken off the paper, thus releasing the rollers 21 and stopping the scanning function. The character recognition and addition is then performed in the CPU 27 and the column result 205 is shown in the result part 233 of the display 23. In the top part 231 of the display 23 is shown the number of column numbers 207 scanned and added. On the left hand side of the device is shown another column 201 that can be scanned. If the clear button 17 is not pressed after scanning the first column, the numbers 2011 of the second column will be added to the column sum of the first column. If the clear button 17 is pressed after scanning the first column, scanning the second column will be a new operation with a separate column sum. Text parts 2013 of a column 201 or other text 202 captured by the scanning input 25 will be recognized as not number related and disregarded in the character recognition process. Negative numbers 2015 will be recognized as such due to the parenthesis or minus signs and will be added with their negative value.

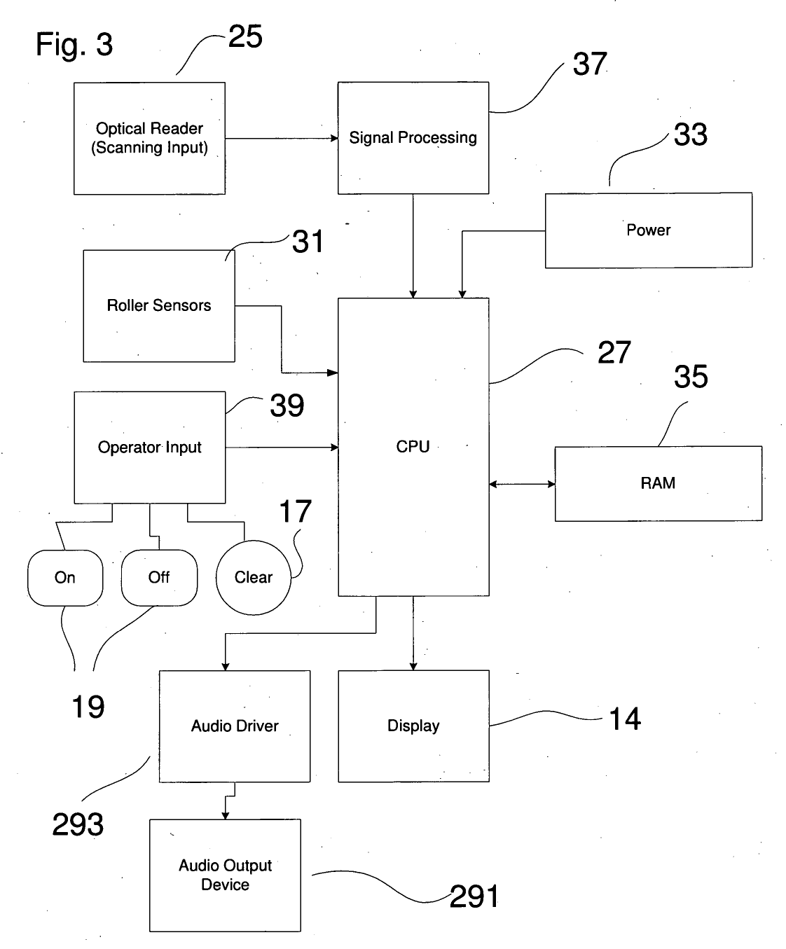

FIG. 3 is a block diagram representation of the components of the handheld vertical scanning calculator of the present invention. The handheld vertical scanning calculator includes a Central Processing (CPU) Unit 27 and associated power circuit 33 and RAM 35. The CPU is connected to the scanning input 25 in the form of an optical reader, which can work with either of a CCD (charge coupled device), a CIS or a CMOS as its sensor unit. The scanning input 25 provides an output analog signal to the signal processing unit 37 which converts the signal to a digital input to the CPU 27. The CPU also receives inputs from the roller sensors 31 regarding the scan speed and regularity of the scanning motion. The CPU 27 is also connected to and receives inputs from the operator input, which includes a number of dedicated buttons for commanding and controlling the device, such buttons include the “on/off” button 19, the “clear”-button 17 as well as any other command buttons that may be desired. The CPU 27 is also connected to audio driver 293, which drives the audio output device 291. CPU 27 is finally connected to an LCD display 23, which displays the sum of the numbers in the scanned column as well as the number of column numbers scanned.

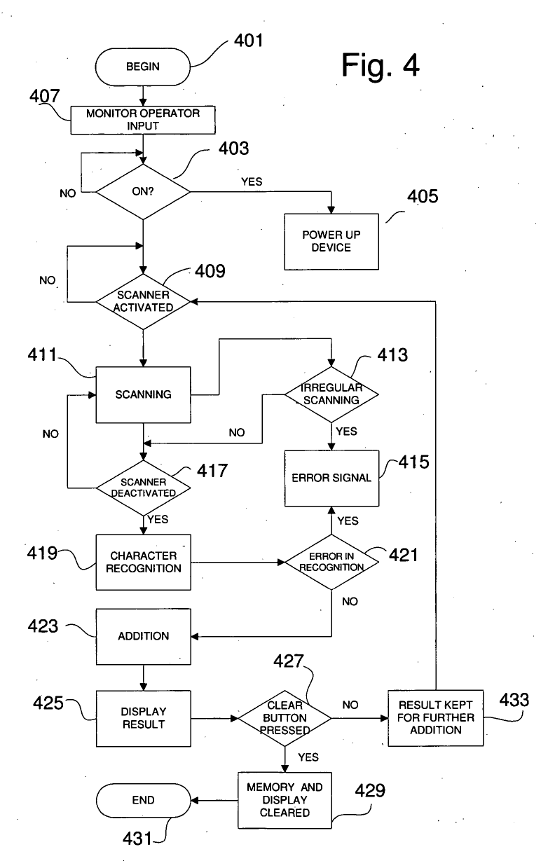

FIG. 4 is a flowchart representation of the operation of the handheld vertical scanning calculator. The process begins at 401 where the apparatus monitors operator input 407. The operator turns on the apparatus 405 via the on/off button 19. If the on button is activated, the apparatus is powered up 405. Hereafter, the CPU 27 monitors whether the approaching end of the device 15 is brought in contact with a surface in which case the rollers 21 are depressed and a signal sent to activate the scanning operation 409 of the scanning input 25. Scanning is then performed 411 until a) the device is lifted off the paper, the pressure on the rollers 15 is released and the scanning input 25 is deactivated 417 or b) irregularities in the scanning process are detected 413 by skips in the pressure on the rollers 21 in which case an error signal is communicated 415 either by the audio output 25 or the display 23 or both and the scanning input 25 is deactivated. If scanning terminates in a regular fashion 417, the CPU 27 and the embedded OCR (Optical Character Recognition) type software then performs the character recognition 419. In case characters in the column 201 are unrecognizable 421, an error signal is communicated 415 audibly and/or through the display 23. If no recognition error is detected, the translated data is sent to the addition program software block in the CPU 27 and addition is performed 423. Negative numbers 2015 in the column 201 marked with “( )” or “-” characters are recognized in the prior step and will be added negatively. After addition, the result is displayed 425 on the display 23. The operator can then clear 427, 429 the display 23 and the memory 231 by pressing the “clear”-button 12 and ending the process 431. If the clear button 17 is not pressed, the result in the display 23 will be kept 433 and will then be added to the subsequent numbers scanned.

1. A handheld vertical scanning calculator apparatus, comprising:
(a) A Scanning Input at the capturing end of the housing for said handheld scanner housing which allows columns of numbers and number related characters to be scanned perpendicular to the vertical scanning movement controlled by the user.
(b) A Controller Unit which performs analog to digital conversion of the image of said numbers and related characters, captured by said scanning input, and through the optical character recognition algorithm converts the digitized image to column oriented numbers and related characters being added and stored into a column sum.
(c) A display attached to said housing, upon which said stored column sum is displayed at the termination of the vertical scanning movement;

2. The handheld vertical scanning calculator apparatus of claim 1 further comprising a data connection for sending data captured by the scanning input and digitized by the OCR program in column format to an external computer or PDA for further processing or storage, said data connection transmitting data either through a cable or through a wireless connection;

3. The handheld vertical scanning calculator apparatus of claim 1 further comprising an audio output unit that transmits audible sound signals in case of scanning or character recognition errors;

4. The handheld vertical scanning calculator apparatus of claim 1 further comprising a housing capable of being operated with one hand by the user;

5. The handheld vertical scanning calculator apparatus of claim 4 further comprising a pen formed housing;

6. The handheld vertical scanning calculator apparatus of claim 1 further comprising the character recognition and calculating programs in separate chips;

7. The handheld vertical scanning calculator apparatus of claim 1 further comprising the calculator functions subtraction, multiplication and division;

8. The handheld vertical scanning calculator apparatus of claim 1 further comprising a sensor that activates the scanning input when the device is brought into contact with the surface on which the numerical characters to be read are carried;

9. The handheld vertical scanning calculator apparatus of claim 1 further comprising roller(s) positioned on at least one side of the scanning input and communicating the line clock scan speed to the controller unit;

10. The handheld vertical scanning calculator apparatus of claim 9 further comprising roller(s), said roller(s) guide the path of the scanning input in a perpendicular straight line over the surface for equidistant and parallel scan line.

11. The handheld vertical scanning calculator apparatus of claim 10 further comprising a motor driving said roller(s) performing said vertical scanning movement under control of said user.
